(19) United States
(12) Patent Application Publication
(10) Pub. No.: US 2025/0042746 A1
(43) Pub. Date: Feb. 6, 2025

(54) CARBON NANOTUBE COMPOSITE AND METHOD FOR PREPARING THE SAME

(71) Applicants: Hyundai Motor Company, Seoul (KR); Kia Corporation, Seoul (KR); Korea Institute of Science and Technology, Seoul (KR)

(72) Inventors: Gwan Sik Kim, Suwon-si (KR); Kyong Hwa Song, Yongin-si (KR); Deok Woo Yun, Hwaseong-si (KR); Hyeon Su Jeong, Wanju-gun (KR); Seung Min Kim, Wanju-gun (KR); Nam Dong Kim, Wanju-gun (KR); Sung Ju Lee, Wanju-gun (KR)

(21) Appl. No.: 18/486,319

(22) Filed: Oct. 13, 2023

(30) Foreign Application Priority Data
Jul. 31, 2023 (KR) 10-2023-0099890

(51) Int. Cl. C01B 32/174; H01G 11/36

(52) U.S. Cl. CPC C01B 32/174; H01G 11/36; C01B 2202/22; C01P 2002/82; C01P 2002/85; C01P 2006/10; C01P 2006/16

(57) ABSTRACT

The present disclosure describes to a method embodiment for preparing a carbon nanotube composite that includes performing a first ultrasonic treatment on a first mixture containing a carbon nanotube (CNT) fiber and an acid to form a carbon nanotube fiber swollen body, and performing a second ultrasonic treatment on a second mixture containing the carbon nanotube fiber swollen body, an aromatic monomer, and an initiator to form a carbon nanotube composite including a surface coated with an aromatic monomer-derived conductive polymer, and an embodiment of the carbon nanotube composite prepared therefrom.

### CROSS-REFERENCE TO RELATED APPLICATIONS

This application claims the benefit of Korean Patent Application No. 10-2023-0099890, filed on Jul. 31, 2023, which application is hereby incorporated herein by reference.

### TECHNICAL FIELD

The present disclosure relates to a carbon nanotube composite.

### BACKGROUND

A conventional general capacitor has high power density but has very low energy density, so that the general capacitor may output high power at once, but have a limit of less energy actually stored because charging and discharging times are too short because of characteristics of the capacitor. On the other hand, a lithium ion battery, which is the most widely used battery, generates electricity via a redux reaction of Li⁺ ions. Such a battery has lower power density than the capacitor, but is accompanied by a chemical reaction. As a result, the battery charges and discharges power slowly for a long time, thereby having an advantage of having high energy density. A supercapacitor has characteristics that lie between those of the conventional capacitor and the battery in terms of the energy density and the power density. In other words, the supercapacitor has advantages of being able to store a large amount of energy compared to the general capacitor, and at the same time, generating a higher output than the battery.

Specifically, the supercapacitor is a capacitor having a great capacitance, and is referred to as an ultra-capacitor or an ultra-high-capacitance capacitor. Unlike the battery that uses the chemical reactions, the supercapacitor is an energy storage device by simple movement of ions at an interface between an electrode and an electrolyte or surface chemical reactions. Because of such characteristics, the supercapacitor is able to perform rapid charging/discharging and has high charging/discharging efficiency and semi-permanent cycle life characteristics, thereby attracting attention as an auxiliary battery or a battery replacement. Such supercapacitors are divided into an electric double layer capacitor (EDLC), a pseudo-capacitor, a hybrid capacitor, and the like. The EDLC uses reversible adsorption and desorption of ions by an electrostatic force, and the pseudo-capacitor stores energy via a redux reaction.

### SUMMARY

The present disclosure relates to a carbon nanotube composite having a great linear density and a great average diameter of a cross-section perpendicular to a longitudinal direction, and a method for preparing the same.

The present disclosure can solve the above-mentioned problems occurring in the prior art while advantages achieved by the prior art can be maintained intact.

An embodiment of the present disclosure provides a carbon nanotube composite that can be suitable as a material of a supercapacitor because of having a great linear density and a great average diameter of a cross-section perpendicular to a longitudinal direction, and thus, having great capacitance, and a method for preparing the same.

Technical problems to be solved by an embodiment of the present disclosure are not necessarily limited to the aforementioned problems, and any other technical problems not mentioned herein can be clearly understood from the following description by those skilled in the art to which the present disclosure pertains.

According to an embodiment of the present disclosure, a method for preparing a carbon nanotube composite includes performing a first ultrasonic treatment on a first mixture containing a carbon nanotube (CNT) fiber and an acid to form a carbon nanotube fiber swollen body, and performing a second ultrasonic treatment on a second mixture containing the carbon nanotube fiber swollen body, an aromatic monomer, and an initiator to form a carbon nanotube composite whose surface is coated with an aromatic monomer-derived conductive polymer.

According to an embodiment of the present disclosure, a carbon nanotube composite includes a carbon nanotube, and an aromatic monomer-derived conductive polymer coated along a surface of the carbon nanotube in a longitudinal direction, and a linear density of the carbon nanotube composite is equal to or greater than 20 g/km.

According to an embodiment of the present disclosure, an electrode for a supercapacitor includes the carbon nanotube composite.

According to an embodiment of the present disclosure, a supercapacitor includes the electrode for the supercapacitor.

### BRIEF DESCRIPTION OF THE DRAWINGS

The above and other features and advantages of an embodiment of the present disclosure can be more apparent from the following detailed description taken in conjunction with the accompanying drawings:

FIGS. 1 and 2 show results of an XPS measurement performed in Test Examples, according to an embodiment of the present disclosure;

FIG. 3 shows results of Raman spectrum measurement performed in Test Examples, according to an embodiment of the present disclosure; and

FIGS. 4 and 5 shows results of measuring electrochemical properties in Test Examples, according to an embodiment of the present disclosure.

### DETAILED DESCRIPTION OF ILLUSTRATIVE EMBODIMENTS

Herein, when a certain portion “includes” a certain component, this can mean that the certain portion may further include other components without necessarily excluding said other components unless otherwise stated.

Herein, when a first member is located on a “surface”, “one surface”, “the other surface” or “both surfaces” of a second member, this can include not only a case in which the first member is in contact with the second member, but also a case in which a third member exists between the two members.

Unless specifically stated or obvious from context, as used herein, the term “about” can be understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

A fiber shaped supercapacitor (FSSC) is in the limelight as an ideal energy storage medium for a wearable smart device. Specifically, a carbon nanotube fiber (CNT fiber or CNTF) has excellent electrical conductivity and mechanical strength, and is attracting attention as a material for a supercapacitor because of flexibility, a possibility of being used in a form of fabric, and the like thereof, for example. However, a conventional CNTF-based FSSC uses only a CNTF having a low linear density (typically equal to or smaller than 0.5 tex (g/km)) and is typically too thin to be commercially applied. In addition, an ultra-thick CNT fiber (UCNTF), which is an industrial CNTF, typically contains an excessively thick CNT bundle and impurities such as amorphous carbon and Fe nanoparticles, so that reliability of a manufactured product is often insufficient. In addition, the UCNTF typically has problems of low crystallinity and electrical conductivity compared to a thin CNTF.

As an alternative thereto, a method for improving capacitance by bundling multiple thin CNTFs or coating another material has been proposed. However, such conventional methods typically require time and/or energy for an additional process or have difficulties in bundling the fibers. Therefore, there is a need for research and development on a method for preparing a carbon nanotube composite having a great linear density, a great average diameter, a great capacitance for a weight, a volume, and a length, and the composite prepared therefrom.

### Method Embodiment for Preparing Carbon Nanotube Composite

A method for preparing a carbon nanotube composite according to an embodiment of the present disclosure includes performing a first ultrasonic treatment and performing a second ultrasonic treatment.

### Performing First Ultrasonic Treatment of a Method Embodiment

In a first step of a method embodiment, a first mixture containing the carbon nanotube (CNT) fiber and acid is subjected to a first ultrasonic treatment to form a carbon nanotube fiber swollen body.

Because of the first ultrasonic treatment of a method embodiment, impurities in the carbon nanotube (CNT) fiber are removed and an attraction between the carbon nanotube bundles in the carbon nanotube fiber is weakened, so that the thick bundle is debundled into several thin bundles. In addition, for a method embodiment, the first mixture contains acid and hydrogen ions (protons) that are inserted into the carbon nanotube fiber to widen a gap between the bundles by a repulsive force and swell the carbon nanotube fiber, and carboxyl and hydroxyl groups are introduced into the swollen body to induce functionalization.

In an embodiment, the carbon nanotube (CNT) fiber may include the bundle in which several carbon nanotubes are bundled together, and may be an ultra-thick CNT fiber (UCNTF). In addition, in an embodiment, the carbon nanotube (CNT) fiber may contain impurities such as amorphous carbon and Fe nanoparticles. In this regard, the carbon nanotube (CNT) bundle can be a bundle in which the several carbon nanotubes are bundled together, and an ultra-thick CNT fiber (UCNTF) can be an aggregate of such CNT bundles. In addition, for an embodiment, the carbon nanotube fiber may contain impurities such as amorphous carbon generated during CNT synthesis and Fe nanoparticles, which are catalysts for the CNT synthesis.

In addition, in an embodiment, the carbon nanotube (CNT) fiber may have a linear density equal to or smaller than 10.5 g/km, or equal to or smaller than 10.4 g/km.

In an embodiment, the carbon nanotube (CNT) fiber may have a specific tensile strength equal to or smaller than 0.14 N/tex, or equal to or smaller than 0.13 N/tex.

In an embodiment, the carbon nanotube (CNT) fiber may have a specific electric conductance equal to or smaller than 350 Sm²/kg, in a range from 150 to 350 Sm²/kg, or in a range from 250 to 300 Sm²/kg.

In an embodiment, the carbon nanotube (CNT) fiber may have an average diameter of a cross-section perpendicular to a longitudinal direction equal to or smaller than 450 Um, in a range from 200 to 450 μm, or in a range from 250 to 400 μm.

In an embodiment, the carbon nanotube (CNT) fiber may have an iron (Fe) content equal to or greater than 7% by weight, equal to or greater than 7.5% by weight, or in a range from 7.5 to 9.0% by weight.

In an embodiment, the carbon nanotube (CNT) fiber may have a surface oxygen content equal to or smaller than 15 atomic %, in a range from 5 to 15 atomic %, or in a range from 8 to 12 atomic %.

In an embodiment, the carbon nanotube (CNT) fiber may have an elongation greater than 20%, greater than 20% and equal to or smaller than 30%, or in a range from 21 to 28%.

In an embodiment, the carbon nanotube (CNT) fiber may have an average pore diameter equal to or smaller than 170 Å, or in a range from 120 to 170 Å.

In an embodiment, the acid may include an inorganic acid. Specifically, the acid may include sulfuric acid, nitric acid, chlorosulfuric acid, fluorosulfuric acid, trifluoroacetic acid, carbolic acid, or any combination thereof, for example. Specifically, for an embodiment, the acid may include sulfuric acid, and more specifically, the acid may include sulfuric acid and nitric acid.

When the acid includes the sulfuric acid and the nitric acid for an embodiment, the acid does not decompose the carbon nanotube and only damages a sp2 structure, thereby causing introduction of an oxygen functional group including the carboxyl and/or hydroxyl groups on a surface of the carbon nanotube. In addition, in an embodiment, as hydrogen ions are inserted into the carbon nanotube fiber, the gap between the carbon nanotube bundles is widened by the repulsive force of the hydrogen ions. In particular, when the first mixture contains the sulfuric acid for an embodiment, sulfuric acid ions (SO₄²⁻) remain in the carbon nanotube fiber and the sulfuric acid ion (SO₄²⁻) acts as a p-dopant on the carbon nanotube with semiconducting properties, thereby improving the electrical conductivity.

In addition, the acid of an embodiment may include sulfuric acid and nitric acid in a volume ratio of 2:1 to 4:1, or 2.5:1 to 3.5:1. When the acid of an embodiment includes sulfuric acid and nitric acid within the above volume ratio range, impurities may be removed without the decomposition of the carbon nanotube, and the effects of causing the swelling and the functionalization of the carbon nanotube fiber may be improved. On the other hand, when the volume ratio of sulfuric acid and nitric acid is lower than the above range, that is, when a small amount of the sulfuric acid is contained relative to the nitric acid, decomposition of the carbon nanotube occurs or the impurity removal and the carbon nanotube fiber swelling can be insufficient. In addition, when the volume ratio of the sulfuric acid and the nitric acid exceeds the above range, that is, when an excessive amount of the sulfuric acid is contained relative to the nitric acid, the oxygen functional group introduced into the carbon nanotube may be insufficient.

In a method embodiment, the first ultrasonic treatment may be performed for 2 to 4 hours with an ultrasonic wave having a frequency in a range from 20 kHz to 50 kHz. Specifically, in an embodiment, the first ultrasonic treatment may be performed for 2.5 hours to 3.5 hours with an ultrasonic wave having a frequency in a range from 30 kHz to 45 kHz, or in a range from 33 kHz to 42 kHz. When the frequency of the ultrasonic wave is lower than the above range during the first ultrasonic treatment, the impurities in the carbon nanotube fibers may not be sufficiently removed. In addition, when the frequency exceeds the above range, a material may be damaged by heat generation and/or the carbon nanotube fiber may be decomposed and broken.

In an embodiment, the carbon nanotube fiber swollen body can be a carbon nanotube fiber swollen by debundling of the carbon nanotube bundle in the carbon nanotube (CNT) fiber, and can include the acid-derived carboxyl group (—COOH) and hydroxyl group (—OH) on the surface of the carbon nanotube.

In an embodiment, the carbon nanotube fiber swollen body may have a linear density in a range from 110 to 140%, in a range from 110 to 130%, or in a range from 114 to 120% of the linear density of the carbon nanotube fiber. That is, the linear density of the carbon nanotube fiber may increase by the first ultrasonic treatment of a method embodiment.

In an embodiment, the carbon nanotube fiber swollen body may have the linear density in a range from 11 to 15 g/km, or from 11 to 13 g/km.

In addition, in an embodiment, an average diameter of a cross-section perpendicular to a longitudinal direction of the carbon nanotube fiber swollen body may be in a range from 150 to 250%, from 170 to 230%, or from 190 to 220% of the average diameter of the cross-section perpendicular to the longitudinal direction of the carbon nanotube fiber. That is, the average diameter of the carbon nanotube fiber may increase by the first ultrasonic treatment of a method embodiment. This is a result of an increase in the average diameter of the carbon nanotube fiber as a carbon nanotube bundle having a large average diameter within the carbon nanotube fiber is debundled into carbon nanotube bundles having a relatively small average diameter, in accordance with an embodiment of the present disclosure. Accordingly, in an embodiment, an average diameter of each bundle in the carbon nanotube fiber may be reduced, and the average diameter of the carbon nanotube fiber including the bundles may be increased.

In an embodiment, the average diameter of the cross-section perpendicular to the longitudinal direction of the carbon nanotube fiber swollen body may be in a range from 500 to 750 μm, or from 550 to 700 μm.

In an embodiment, an average pore diameter of the carbon nanotube fiber swollen body may be in a range from 120 to 160%, from 125 to 155%, or from 130 to 150%, of the average pore diameter of the carbon nanotube fiber. That is, the average diameter of the carbon nanotube fiber may increase by the first ultrasonic treatment of a method embodiment. In this regard, in an embodiment, the average pore diameter may be an average value of pore diameters measured by the Barrett-Joyner-Halenda (BJH) method.

In addition, in an embodiment, the average pore diameter of the carbon nanotube fiber swollen body may be in a range from 180 to 250 Å or from 200 to 230 Å.

In an embodiment, a surface oxygen content of the carbon nanotube fiber swollen body may be in a range from 150 to 450%, from 180 to 320%, or from 200 to 300%, of the surface oxygen content of the carbon nanotube fiber. That is, because of the first ultrasonic treatment of a method embodiment, the carboxyl group (—COOH) and the hydroxyl group (—OH) containing oxygen may be introduced to the surface of the carbon nanotube fiber.

In addition, for an embodiment, the surface oxygen content of the carbon nanotube fiber swollen body may be in a range from 20 to 30 atomic % or from 23 to 28 atomic %.

### Performing Second Ultrasonic Treatment of a Method Embodiment

In a second step of a method embodiment, a second mixture containing the carbon nanotube fiber swollen body, an aromatic monomer, and an initiator is subjected to the second ultrasonic treatment to form a carbon nanotube composite whose surface is coated with an aromatic monomer-derived conductive polymer.

Because of the second ultrasonic treatment of a method embodiment, radicals derived from the aromatic monomer facilitates synthesis of the conductive polymer.

The aromatic monomer may include, for example, aniline, pyrrole, indole, thiophene, phenylene sulfide, or any combination thereof. In this regard, the aromatic monomer may be substituted or unsubstituted. Specifically, in an embodiment, the aromatic monomer may include substituted or unsubstituted aniline.

In an embodiment, the initiator serves to induce a reaction in which the aromatic monomer is polymerized into the conductive polymer. In addition, the initiator may include, for example, ammonium persulfate (APS), ammonium dichromate, copper (II) chloride, hydrogen peroxide, or any combination thereof. Specifically, in an embodiment, the initiator may include ammonium persulfate.

The second mixture of an embodiment may contain 20000 to 25000 parts by weight, or specifically 22000 to 24000 parts by weight, of the aromatic monomer based on 100 parts by dry weight of the carbon nanotube fiber swollen body. When the carbon nanotube fiber swollen body and the aromatic monomer are contained within the above range for an embodiment, the aromatic monomer can be evenly distributed in the carbon nanotube fiber, and thus, the conductive polymer can be linearly polymerized. On the other hand, when the content of the aromatic monomer is lower than the above range, that is, when a small amount of the aromatic monomer is contained in the carbon nanotube fiber swollen body, continuous polymerization may not be able to be performed linearly because of lack of the aromatic monomer or a sufficient amount of the conductive polymer may not be able to be synthesized. On the other hand, when the content of the aromatic monomer exceeds the above range, that is, when an excessive amount of the aromatic monomer is contained with respect to the carbon nanotube fiber swollen body, the conductive polymer may be excessively synthesized and aggregated, and thus, may not be evenly distributed on the carbon nanotube fiber.

The second mixture of an embodiment may contain 12,000 to 16,000 parts by weight, or specifically 14,000 to 15,000 parts by weight, of the initiator, based on 100 parts by dry weight of the carbon nanotube fiber swollen body. When the carbon nanotube fiber swollen body and the initiator are contained within the above weight range, the aromatic monomer can be synthesized into a conductive polymer having high conductivity. On the other hand, when the content of the initiator is smaller than the above range, that is, when a small amount of the initiator is contained relative to the carbon nanotube fiber swollen body, the conductive polymer may not be well synthesized or the conductivity thereof may be poor. In addition, when the content of the initiator exceeds the above range, that is, when an excessive amount of initiator is contained in the carbon nanotube fiber swollen body, the conductive polymer may not be polymerized linearly, resulting in poor conductivity.

The second ultrasonic treatment of a method embodiment may be performed for 2 to 4 hours with an ultrasonic wave having a frequency in a range from 30 kHz to 50 kHz. Specifically, in an embodiment, the second ultrasonic treatment may be performed for 2.5 to 3.5 hours with an ultrasonic wave having a frequency in a range from 35 kHz to 45 kHz. When the frequency of the ultrasonic wave during the second ultrasonic treatment is lower than the above range, energy required to synthesize the conductive polymer can be insufficient. In addition, when the frequency exceeds the above range, a structure of the carbon nanotube fiber may be damaged or the conductivity of the conductive polymer may be lost because of heat generation. In addition, when a treatment time of the ultrasonic wave in the second ultrasonic treatment is shorter than the above range, the conductive polymer may not be able to be linearly polymerized because of insufficient time. In addition, when the treatment time exceeds the above range, excessive synthesis of the conductive polymer and/or the loss of the conductivity may occur because of the heat generation.

In an embodiment, the conductive polymer is coated on the surface of the carbon nanotube and can improve capacitance of the carbon nanotube fiber swollen body via a redux reaction. In this regard, the conductive polymer of an embodiment may contain a repeating unit containing nitrogen or sulfur inside or outside an aromatic ring in a main chain. For example, the conductive polymer of an embodiment may include an aniline-based polymer, a pyrrole-based polymer, a thiophene polymer, a poly(phenylene sulfide)-based polymer, or any combination thereof. Specifically, the conductive polymer of an embodiment may include an aniline-based polymer and a poly(phenylene sulfide)-based polymer. More specifically, the conductive polymer of an embodiment may include an aniline-based polymer in which the substituted or unsubstituted aniline is polymerized.

A method for preparing a carbon nanotube composite according to an embodiment of the present disclosure as described above may easily prepare the carbon nanotube composite having a low impurity content. In addition, a carbon nanotube composite prepared by the above method embodiment can have a great linear density and a great average diameter of the cross-section perpendicular to the longitudinal direction, and can have a great capacitance, so that the carbon nanotube composite can be very suitable as a material for a supercapacitor.

### Carbon Nanotube Composite Embodiment

A carbon nanotube composite according to an embodiment of the present disclosure contains a carbon nanotube and an aromatic monomer-derived conductive polymer coated along surfaces in the longitudinal direction of the carbon nanotube.

In an embodiment, the carbon nanotube composite can have a linear density equal to or greater than 20 g/km. Specifically, the carbon nanotube composite of an embodiment may have a linear density in a range from 20 to 35 g/km, from 25 to 30 g/km, or from 27 to 30 g/km. When the linear density of the carbon nanotube composite is within the above range, the carbon nanotube composite can be very suitable as a material for an electrode for supercapacitors because of high linear density.

In an embodiment, the conductive polymer is coated on the surface of the carbon nanotube and improves the capacitance of the carbon nanotube fiber swollen body via the redux reaction. In this regard, the conductive polymer of an embodiment may contain the repeating unit containing nitrogen or sulfur inside or outside the aromatic ring in the main chain. For example, the conductive polymer of an embodiment may include an aniline-based polymer, a pyrrole-based polymer, a thiophene polymer, a poly(phenylene sulfide)-based polymer, or any combination thereof, for example. Specifically, the conductive polymer of an embodiment may include an aniline-based polymer and a poly(phenylene sulfide)-based polymer. More specifically, the conductive polymer of an embodiment may include an aniline-based polymer in which the substituted or unsubstituted aniline is polymerized.

In an embodiment, the carbon nanotube composite may have a specific electric conductance in a range from 700 to 1,000 Sm²/kg or from 750 to 850 Sm²/kg.

In addition, the carbon nanotube composite of an embodiment may have a surface oxygen content in a range from 20 to 30 atomic % or from 23 to 28 atomic %.

The carbon nanotube composite of an embodiment may have an elongation in a range from 10 to 20% or from 11 to 14%.

In addition, in an embodiment, an average pore diameter of the carbon nanotube composite may be in a range from 180 to 250 Å or from 200 to 230 Å.

As described above, the carbon nanotube composite according to an embodiment of the present disclosure can have a low impurity content, can be rich in the oxygen functional group that may cause the redux reaction, can have a great linear density and a great average diameter of the cross-section perpendicular to the longitudinal direction, and can have a great capacitance, so that the carbon nanotube composite can be very suitable as a material for a supercapacitor.

### Electrode for Supercapacitor Embodiment

An electrode for a supercapacitor according to an embodiment of the present disclosure includes the carbon nanotube composite as described above. The electrode for the supercapacitor of an embodiment may improve length capacitance (C_{L}), volumetric capacitance (C_{V}), and specific capacitance (C_{SP}) of the supercapacitor including the carbon nanotube composite because of the above-described advantages of a carbon nanotube composite embodiment.

### Supercapacitor Embodiment

A supercapacitor according to an embodiment of the present disclosure includes the electrode for the supercapacitor as described above.

A supercapacitor of an embodiment may have a length capacitance (C_{L}) equal to or greater than 80 mF/cm, in a range from 80 to 130 mF/cm, or in a range from 80 to 110 mF/cm.

In addition, a supercapacitor of an embodiment may have a specific capacitance (C_{SP}) equal to or greater than 300 F/g, in a range from 300 to 500 F/g, or in a range from 300 to 450 F/g.

In an embodiment, a supercapacitor may have a change in capacitance after bending by 90° equal to or smaller than 5%.

In addition, a supercapacitor of an embodiment may have a volumetric capacitance (C_{V}) equal to or greater than 450 F/cm³ or in a range from 450 to 600 F/cm³.

As described above, a supercapacitor according to an embodiment of the present disclosure can have excellent length capacitance (C_{L}), volumetric capacitance (C_{V}), and specific capacitance (C_{SP}), and can have excellent durability, so that the supercapacitor can be very suitable as a material for various energy storage media requiring flexibility such as a wearable smart device.

Hereinafter, embodiments of the present disclosure will be described in more detail through Present Examples. However, such Present Examples are only for helping understanding embodiments of the present disclosure, and the scope of the present disclosure is not necessarily limited to such Present Examples in any sense.

### PRESENT EXAMPLES

### Preparation Example 1: Preparation of Carbon Nanotube Composite-1

A 40 cm (length) carbon nanotube fiber (e.g., UCNTF, manufacturer: JEIO) having an average diameter in a range from 300 to 320 μm and a linear density of 10.3 tex was mixed with 8 mL of an acid solution (containing sulfuric acid and nitric acid in a volume ratio of 3:1) to prepare a first mixture of an embodiment.

Thereafter, the first mixture was subjected to a first ultrasonic treatment of a method embodiment with the ultrasonic wave having the frequency of 40 kHz for 3 hours to prepare a carbon nanotube fiber swollen body (S-UCNTF) in accordance with an embodiment of the present disclosure.

Thereafter, a second mixture of a method embodiment was prepared by mixing 0.0048 g of the carbon nanotube fiber swollen body (S-UCNTF), 1.12 g of the aniline as the aromatic monomer, and 0.699 g of the ammonium persulfate (APS). Thereafter, the second mixture was subjected to a second ultrasonic treatment of a method embodiment with the ultrasonic wave having the frequency of 40 kHz for 3 hours to prepare a carbon nanotube composite (0.2P/S-UCNTF)-1 whose surface is coated with polyaniline.

### Preparation Example 2

In an embodiment, 0.0048 g of carbon nanotube fiber (e.g., UCNTF, manufacturer: JEIO) (average diameter: 300 to 320 μm, linear density: 10.3 tex), 1.12 g of aniline as an aromatic monomer, and 0.699 g of ammonium persulfate (APS), were mixed with each other and then a second ultrasonic treatment of a method embodiment was performed with the ultrasonic wave having the frequency of 40 kHz for 3 hours to prepare a carbon nanotube fiber (0.2P/UCNTF) whose surface is coated with the polyaniline.

### Preparation Examples 3 to 5

For embodiments, carbon nanotube composites were prepared in the same manner as in Preparation Example 1, except that contents of the aniline with respect to a dry weight of the carbon nanotube fiber swollen body were adjusted as shown in Table 1 below.

TABLE 1

| | Weight of carbon nanotube | Weight of |
|---|---|---|
| | fiber swollen body | aniline |
| Preparation Example 1 | 0.0048 g | 1.12 g |
| (0.2P/S-UCNTF) | | |
| Preparation Example 3 | 0.0048 g | 0.28 g |
| (0.05P/S-UCNTF) | | |
| Preparation Example 4 | 0.0048 g | 0.56 g |
| (0.1P/S-UCNTF) | | |
| Preparation Example 5 | 0.0048 g | 1.68 g |
| (0.3P/S-UCNTF) | | |

### Test Example 1: Evaluation of Characteristics

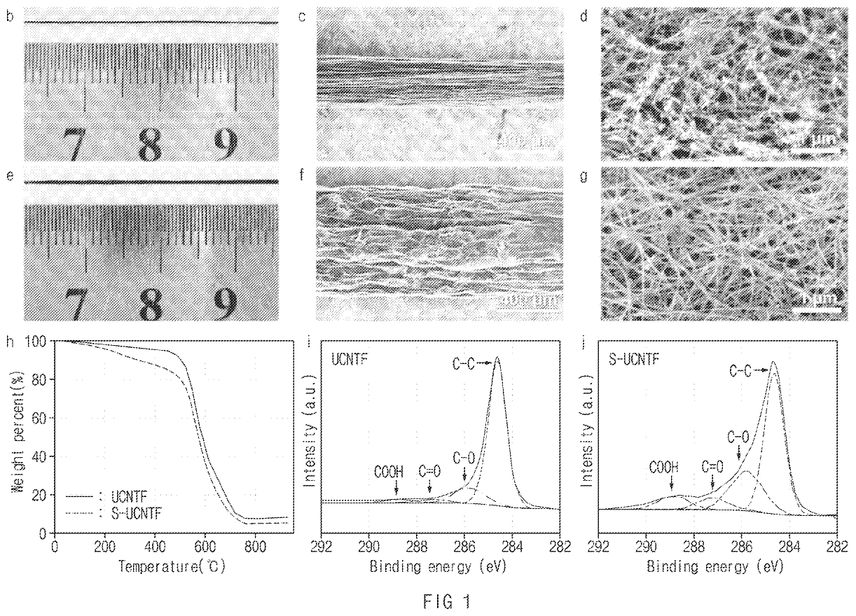

Physical properties of the products prepared in Preparation Examples 1 to 5 were evaluated in a following manner, and results thereof are shown in Table 2 and FIGS. 1 to 3.

(1) Linear density: Weights of the 20 cm carbon nanotube fiber or the carbon nanotube composite were measured three times with a microbalance, averaged, and calculated based on g/km (tex), a unit of the linear density.

(2) Average diameter of cross-section perpendicular to longitudinal direction: More than 10 areas of the fiber were photographed with a scanning electron microscope (SEM) to measure the diameter and calculate an average value.

(3) Specific capacitance (C_{SP}): The specific capacitance was measured using a potentiostat. Specifically, a three-electrode experiment uses a 0.5 M sulfuric acid solution as an electrolyte, a platinum plate as a counter electrode, a silver-silver chloride electrode (Ag/AgCl) as a reference electrode, and a 3 cm long carbon nanotube composite as a working electrode. After setting a discharge voltage to 0 V and a charge voltage to 0.8 V, a measurement was performed at a current scanning rate of 1 A/g.

(4) Specific electric conductance: A measurement was performed using 4-probe measurement. Specifically, four points were set on the carbon nanotube fiber or the carbon nanotube composite at spacings of 1 cm, 2 cm, and 1 cm from a frontmost point. Then, a probe that passes current to outer two points and a probe that measures voltages at inner two points were connected to each other. Then, a current of 100 mA was passed and a resistance was obtained from a measured voltage value to calculate the electrical conductivity.

(5) Elongation: Using a single fiber physical property tester (FAVIMAT+), elongation until just before the carbon nanotube fiber or the carbon nanotube composite was broken under conditions of a 0-2 N load cell, a gauge length of 20 mm, and a tensile speed of 2 mm/min was measured.

(6) Crystallinity (I_{G}/I_{D}): The crystallinity was measured by a ratio of a G peak and a D peak obtained by irradiating the carbon nanotube fiber or the carbon nanotube composite with light having a wavelength of 532 nm using a Raman spectrometer.

(7) Iron (Fe) content (impurity content): After 50 mg of the carbon nanotube fiber or the carbon nanotube composite were put into a thermogravimetric analyzer and heated from 25° C. to 950° C. for thermal decomposition, a weight of a remaining iron catalyst was measured, and calculated as mass % (wt %) relative to 50 mg of the carbon nanotube fiber or the carbon nanotube composite.

(8) Surface oxygen content: A measurement was performed via quantitative analysis of elements constituting the surface of the carbon nanotube fiber or the carbon nanotube composite in X-ray photoelectron spectroscopy.

(9) Average pore diameter: 50 mg of the carbon nanotube fiber or the carbon nanotube composite was put into a Brunauer Emmett Teller (BET) physisorption analyzer and nitrogen gas was adsorbed thereto to measure the average diameter of the pores inside the carbon nanotube fiber or the carbon nanotube composite.

TABLE 2

| | | | 0.2P/S- | 0.05P/S- | 0.1P/S- | 0.3P/S- |
|---|---|---|---|---|---|---|
| | UCNTF of | S-UCNTF of | UCNTF of | UCNTF of | UCNTF of | UCNTF of |
| | Preparation | Preparation | Preparation | Preparation | Preparation | Preparation |
| | Example 2 | Example 1 | Example 1 | Example 3 | Example 4 | Example 5 |
| Linear density (tex, | 10.3 | 12.0 | 28.8 | 16.3 | 17.0 | 24.6 |
| g/Km) | | | | | | |
| Specific Tensile | 0.13 | 0.16 | — | — | — | — |
| strength (N/tex) | | | | | | |
| Specific capacitance | 12 | 28 | 390 | 196 | 193 | 208 |
| (F/g)(C_{SP}) | | | | | | |
| Length capacitance | 1.2 | 3.3 | 96.5 | 31.9 | 32.8 | 51.1 |
| (mF/cm)(C_{L}) | | | | | | |
| Volumetric | — | — | 523.3 | — | — | — |
| capacitance | | | | | | |
| (F/cm³)(Cᵥ) | | | | | | |
| Specific electrical | 275.1 | 807.7 | — | — | — | — |
| conductivity (Sm²/kg) | | | | | | |
| Elongation (%) | 24.5 | 12.5 | — | — | — | — |
| Crystallinity (I_{G}/I_{D}) | 3.12 | 3.07 | 3.07 | 3.07 | 3.07 | 3.07 |
| Average diameter | 310 | 630 | 630 | 630 | 630 | 630 |
| (μm) | | | | | | |
| Fe impurity (wt %) | 8.5 | 5.8 | 5.8 | 5.8 | 5.8 | 5.8 |
| Oxygen content | 9.9 | 25.0 | — | — | — | — |
| (atomic %) | | | | | | |
| BJH adsorption | 0.32 | 0.42 | — | — | — | — |
| volume of pores | | | | | | |
| (cm³/g) | | | | | | |
| Average pore diameter | 151.7 | 211.9 | — | — | — | — |
| (Å) | | | | | | |

As shown in Table 2, the carbon nanotube composite (P/S-UCNTF) according to an embodiment of the present disclosure has a great linear density and great capacitance for the weight, the volume, and the length, so that it was found that the carbon nanotube composite (P/S-UCNTF) is very suitable for a wearable device, smart fabric, a self-powered material, and the like. In particular, 0.2P/S-UCNTF of Preparation Example 1 had great linear density and significantly great capacitance for the weight, the volume, and the length.

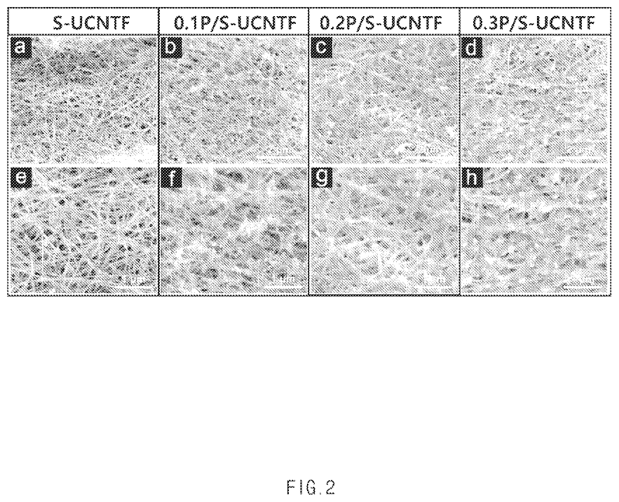

(10) XPS measurement: After fixing the carbon nanotube fiber or the carbon nanotube fiber swollen body with copper tape on a silicon wafer, five or more areas were scanned in X-ray photoelectron spectroscopy (XPS), and results are shown in FIGS. 1 and 2.

As shown in FIG. 1, an intensity of a peak related to oxygen increased in the carbon nanotube fiber swollen body (S-UCNTF) of an embodiment compared to the carbon nanotube fiber (UCNTF), in particular, peaks of the hydroxyl group (—OH) and the carboxyl group (—COOH) markedly increased. This is determined to be a result of intentionally damaging the carbon nanotube surface using the acid solution for the introduction of the oxygen functional group. In addition, it is determined that the oxygen functional group will improve hydrophobic properties of the CNT, thereby improving wettability of the CNT. Furthermore, it is determined that pseudocapacitance will be increased by promoting a redox reaction with the electrolyte.

As shown in FIG. 2, it was found that the 0.1P/S-UCNTF of Preparation Example 4 had a granular structure, the 0.2P/S-UCNTF of Preparation Example 1 had a fibril morphology, and the 0.3P/S-UCNTF of Preparation Example 5 had an aggregate of PANI and a carbon nanotube (CNT) bundle whose surface is not uniformly coated.

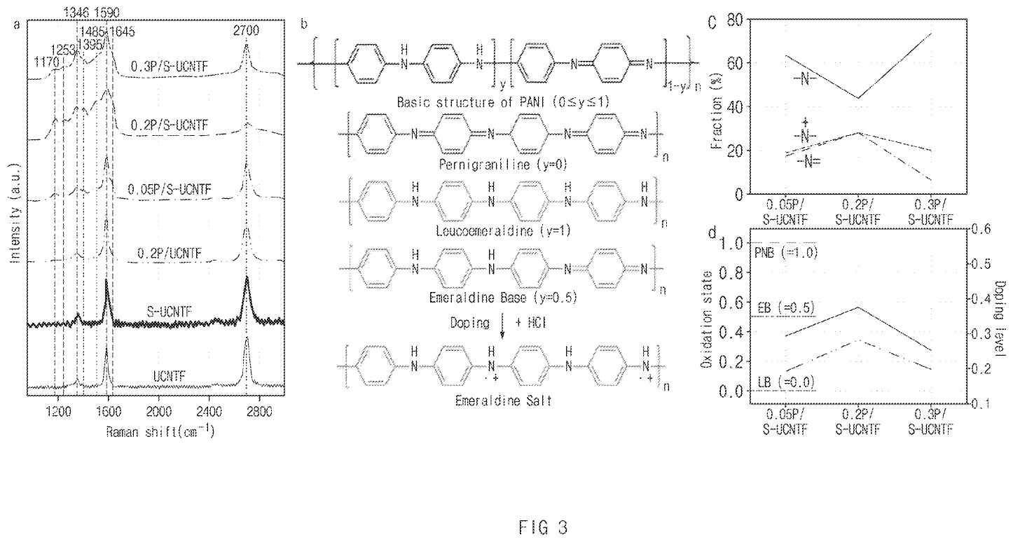

(11) Raman measurement: A ray of 532 nm wavelength was irradiated to the fiber of an embodiment to measure a Raman spectrum, and results are shown in FIG. 3.

As shown in FIG. 3, it was seen that CNT peaks of an embodiment were D-band (1350 cm⁻¹), G-band (1590 cm⁻¹), and 2D-band (2700 cm⁻¹), and the PANI was coated and PANI-related peaks were 1170 cm⁻¹, 1252 cm⁻¹, 1346 cm⁻¹, and 1485 cm⁻¹. In addition, an oxidation state of an embodiment was −N=+N⁺/Nₜₒₜₐₗ of 0.5, and it was identified as a result of doping that a performance as a supercapacitor significantly improved as the N⁺/Nₜₒₜₐₗ increased.

### Test Example 2: Evaluation of Characteristics

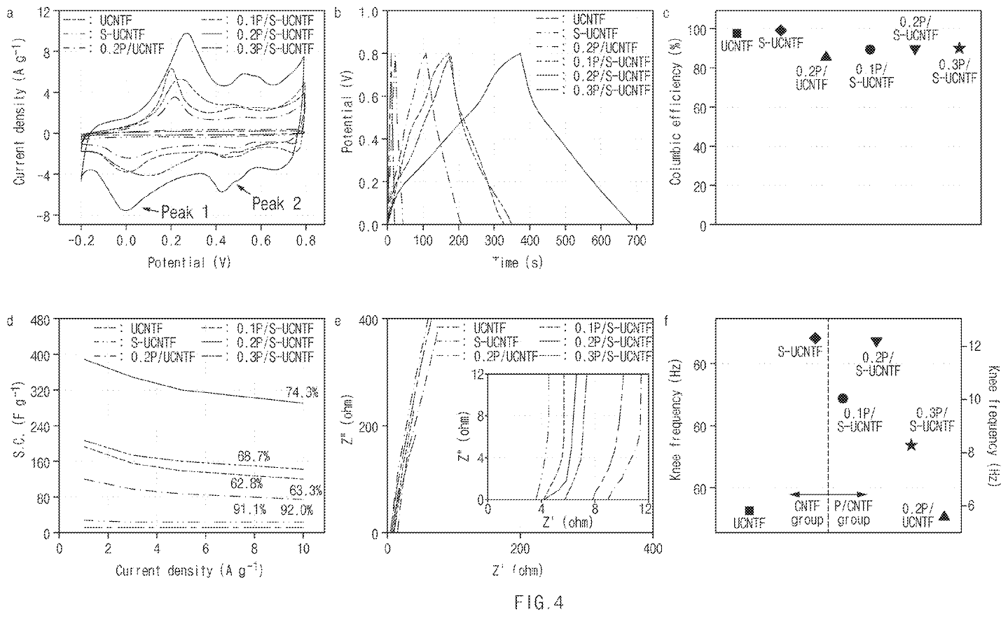

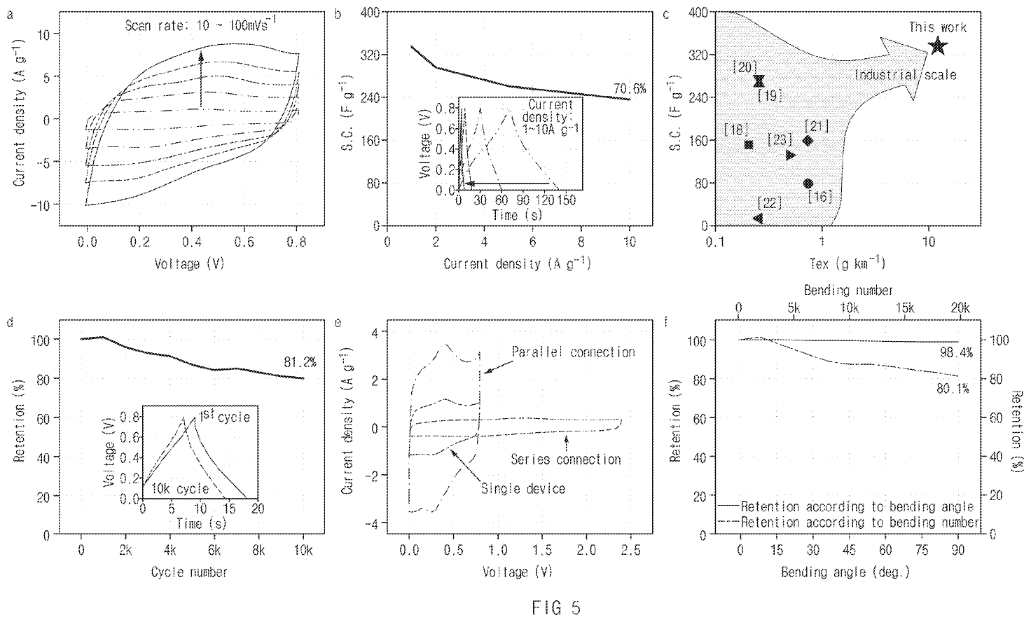

Physical properties of the products prepared in Preparation Examples 1 to 5 according to embodiments of the present disclosure were evaluated in a following manner, and results thereof are shown in FIGS. 4 and 5.

(12) Current density: While applying a voltage in a range from −0.2 V to 0.8 V at a scan rate of 0.01 V/s via cyclic voltammetry, a current density was calculated by dividing a measured current by a mass of the carbon nanotube fiber and/or the carbon nanotube composite used.

(13) Potential: A current of 1 A/g was passed through the carbon nanotube fiber and/or the carbon nanotube composite via the galvanostatic charge-discharge to measure a voltage change within a range from 0 V to 0.8 V.

(14) Columbic efficiency: The current of 1 A/g was passed through the carbon nanotube fiber and/or the carbon nanotube composite via the galvanostatic charge-discharge to calculate a concordance rate between a charge time from 0 V to 0.8 V and a discharge time from 0.8 V to 0 V. In this regard, the closer the concordance rate is to 100, the better the cyclability.

(15) S.C (specific capacitance (F/g)): A measurement was performed in the same manner as in item (3) in Test Example 1.

(16) Z″: Impedance measured via electrochemical impedance spectroscopy was represented by an x-axis and a y-axis, respectively, with Z′ as a real part and Z′ as an imaginary part.

(17) Knee frequency: A knee frequency is a value obtained by measuring a frequency at a point at which a phase angle becomes 45° via the electrochemical impedance spectroscopy. It may be interpreted that the higher the value, the better the rate capability.

As shown in FIG. 4, it was found that the UCNTF of Preparation Example 1 exhibited electrical double layer capacitance (EDLC) characteristics, and changed to a pseudocapacitive mechanism based on the introduction of the PANI. It was found that a redox peak exists in a specific voltage range different from that of the UCNTF by the redox reaction of the PANI because more PANI may be introduced with a large specific surface area and the oxygen functional group of the S-UCNTF.

In addition, high Columbic efficiency (89.3%) and low IR drop were shown because of the high electrical conductivity of the CNTF and uniform deposition of the PANI without the agglomeration.

Furthermore, it was found that the functionalized CNTF of an embodiment can have improved accessibility of electrolyte ions because of the improved wettability and has a high doping level and the oxidation state, thereby increasing various electrochemical properties.

(18) Current density: A measurement was performed in the same manner as in the item (12) above. Specifically, FIG. 5 is a result of measuring the current density based on a scan rate by adjusting the scan rate within a range from 10 to 100 mV/s for one two-electrode device. In addition, e in FIG. 5 is a result showing the current density measured after connecting three two-electrode devices in parallel (blue) or in series (red) with the scan rate fixed at 10 mV/s. Furthermore, a black graph in e in FIG. 5 is a result of measuring a current density of only one two-electrode device.

(19) S.P. (specific capacitance, Cₛₚ): A measurement was performed in the same manner as the item (3) in Test Example 1.

(20) Retention: A cycle retention in d in FIG. 5 shows % of specific capacitance after charging and discharging 10,000 times at a scan rate of 5 A/g for a two-electrode device using the 0.2P/S-UCNTF as an electrode with respect to specific capacitance after 1 time of charging and discharging.

In addition, a retention for a bending angle in f in FIG. 5 shows a degree of retention of the specific capacitance when the two-electrode device is bent from 0° to 90°, and a retention for the bending number shows a degree of retention of the specific capacitance when bending of the two-electrode device from 0° to 90° is repeated for 20,000 times.

In this regard, the specific capacitance was measured in the same manner as in the item (3) of Test Example 1.

As shown in FIG. 5, in the evaluation using the two-electrode symmetric device, stable capacitive characteristics of 335 F/g were exhibited (see c in FIG. 5). In addition, it was found that the electrochemical properties of embodiments were improved based on the high doping level because of interaction between the ultra-thick CNTF and the PANI.

Furthermore, it was found that the 0.2P/S-UCNTF of Preparation Example 1 has the improved linear density (Tex) and the Cₛₚ, making it more suitable as the material of a supercapacitor (see c in FIG. 5).

In addition, as a result of the charging/discharging 10,000 cycle evaluation, it was found that the 0.2P/S-UCNTF of Preparation Example 1 showed 81.2% (at 5 A/g) (see d in FIG. 5), and stably operated in both of the series/parallel cases (see e in FIG. 5).

Furthermore, as a result of the 0-90° bending test 20,000 cycle evaluation, it was found that the 0.2P/S-UCNTF of Preparation Example 1 showed 80.1%, indicating excellent durability (see f in FIG. 5).

The carbon nanotube composite according to an embodiment of the present disclosure can have a great linear density and a great average diameter of the cross-section perpendicular to the longitudinal direction, and thus can have a great capacitance, so that the carbon nanotube composite can be very suitable as a material for a supercapacitor.

In addition, a supercapacitor containing the carbon nanotube composite of an embodiment can have excellent durability and flexibility and can have a great capacitance, so that the supercapacitor can be very suitable for a wearable device, a smart fabric, a self-powered material, and the like, for example.

Furthermore, a method for preparing a carbon nanotube composite according to an embodiment of the present disclosure may easily prepare the carbon nanotube composite having low impurity content.

Hereinabove, although embodiments of the present disclosure has been described with reference to exemplary examples and the accompanying drawings, the present disclosure is not necessarily limited thereto, but an embodiment may be variously modified and altered by those skilled in the art to which the present disclosure pertains without departing from the spirit and scope of the present disclosure claimed in the following claims.

What is claimed is:

1. A method for preparing a carbon nanotube composite, the method comprising:
performing a first ultrasonic treatment on a first mixture, the first mixture containing a carbon nanotube (CNT) fiber and an acid, to form a carbon nanotube fiber swollen body; and
performing a second ultrasonic treatment on a second mixture, the second mixture containing the carbon nanotube fiber swollen body, an aromatic monomer, and an initiator, to form a carbon nanotube composite including a surface coated with an aromatic monomer-derived conductive polymer.

2. The method of claim 1, wherein the acid comprises an inorganic acid.

3. The method of claim 2, wherein the acid contains sulfuric acid and nitric acid.

4. The method of claim 3, wherein the acid contains the sulfuric acid and the nitric acid in a volume ratio from 2:1 to 4:1.

5. The method of claim 1, wherein the first ultrasonic treatment is performed with an ultrasonic wave having a first frequency in a range from 20 kHz to 50 kHz, for 2 to 4 hours, and wherein the second ultrasonic treatment is performed with an ultrasonic wave having a second frequency in a range from 30 kHz to 50 kHz, for 2 to 4 hours.

6. The method of claim 1, wherein the conductive polymer contains a repeating unit containing nitrogen or sulfur, inside or outside an aromatic ring in a main chain.

7. The method of claim 6, wherein the conductive polymer includes one of or any combination of an aniline-based polymer, a pyrrole-based polymer, a thiophene polymer, and a poly(phenylene sulfide)-based polymer.

8. The method of claim 1, wherein the second mixture contains 20000 to 25000 parts by weight of the aromatic monomer relative to 100 parts by dry weight of the carbon nanotube fiber swollen body.

9. The method of claim 1, wherein a linear density of the carbon nanotube fiber swollen body is 110 to 140% of a linear density of the carbon nanotube fiber.

10. The method of claim 1, wherein an average diameter of a cross-section perpendicular to a longitudinal direction of the carbon nanotube fiber swollen body is 150 to 250% of an average diameter of a cross-section perpendicular to a longitudinal direction of the carbon nanotube fiber.

11. The method of claim 1, wherein an average pore diameter of the carbon nanotube fiber swollen body is 120 to 160% of an average pore diameter of the carbon nanotube fiber.

12. The method of claim 1, wherein a surface oxygen content of the carbon nanotube fiber swollen body is 150 to 450% of a surface oxygen content of the carbon nanotube fiber.

13. A carbon nanotube composite comprising:
a carbon nanotube; and
an aromatic monomer-derived conductive polymer coated along a surface of the carbon nanotube in a longitudinal direction,
wherein a linear density of the carbon nanotube composite is equal to or greater than 20 g/km.

14. The carbon nanotube composite of claim 13, wherein the conductive polymer comprises one of or any combination of an aniline-based polymer, a pyrrole-based polymer, a thiophene polymer, and a poly(phenylene sulfide)-based polymer.

15. The carbon nanotube composite of claim 13, wherein specific electric conductance of the carbon nanotube composite is in a range from 700 to 1,000 Sm²/kg and a surface oxygen content of the carbon nanotube composite is in a range from 20 to 30 atomic %.

16. The carbon nanotube composite of claim 13, wherein an elongation is in a range from 10 to 20%, and an average pore diameter is in a range from 180 to 250 Å.

17. An electrode for a supercapacitor comprising the carbon nanotube composite of claim 13.

18. A supercapacitor comprising an electrode, wherein the electrode comprises the carbon nanotube composite of claim 13.

19. The supercapacitor of claim 18, wherein length capacitance (C_{L}) of the supercapacitor is equal to or greater than 80 mF/cm, specific capacitance (C_{SP}) of the supercapacitor is equal to or greater than 300 F/g, and a capacitance change after 90° bending of the supercapacitor is equal to or less than 5%.
